(19) United States
(12) Patent Application Publication
(10) Pub. No.: US 2016/0064739 A1
(43) Pub. Date: Mar. 3, 2016

(54) BATTERY AND ELECTRONIC DEVICE

(71) Applicants: BEIJING LENOVO SOFTWARE LTD., Beijing (CN); LENOVO (BEIJING) LIMITED, Beijing (CN)

(72) Inventor: Haifeng Yu, Beijing (CN)

(21) Appl. No.: 14/657,441

(22) Filed: Mar. 13, 2015

(30) Foreign Application Priority Data
Aug. 26, 2014 (CN) 201410426289.3

(51) Int. Cl. H01M 4/80; H01M 4/131; H01M 4/133; H01M 2/18; H01M 4/505; H01M 4/587; H01M 4/66; H01M 2/16; H01M 10/0525; H01M 4/525

(52) U.S. Cl. CPC H01M 4/80; H01M 10/0525; H01M 4/131; H01M 4/133; H01M 4/525; H01M 4/505; H01M 4/587; H01M 4/661; H01M 2/1653; H01M 2/18; H01M 2220/30

(57) ABSTRACT

The disclosure provides a battery and an electronic device. The battery comprises: a porous metal positive electrode plate having a plurality of pores filled with positive electrode material, which is used in a cathode reaction within the battery; a porous metal negative electrode plate having a plurality of pores filled with negative electrode material, which is used in an anode reaction within the battery; a first separating film arranged between the porous metal positive electrode plate and the porous metal negative electrode plate; and a second separating film covering a lower surface of the porous metal negative electrode plate, the lower surface is not in contact with the first separating film. According to the disclosure, the battery's cathode and anode are made of porous metals respectively filled with the positive electrode material and the negative electrode material. As such, internal resistances of the positive and the negative electrodes of the battery are reduced, thereby enabling the battery to charged and discharged rapidly.

### PRIORITY APPLICATION

This application claims the benefit under 35 U.S.C. 119 to Chinese Application No. 201410426289.3, filed on 26 Aug. 2014; which application is incorporated herein by reference in its entirety.

### TECHNICAL FIELD

The disclosure generally relates to the field of electronic technology, and particularly, to a battery and an electronic device.

### BACKGROUND

Nowadays, portable electronic devices are becoming lighter and thinner, which puts forward higher requirements for batteries in the portable electronic devices.

The structure of batteries that are currently in use is shown in FIG. 1. As illustrated, such a battery consists of, from top to bottom, an aluminum foil, a positive electrode layer, a separating film, a negative electrode layer, a copper foil and a separating film. The positive electrode layer is made of positive electrode material, which is prepared from lithium cobaltate or lithium manganate powder. The negative electrode layer is made of negative electrode material, which is prepared from graphite powder. As the positive electrode layer and the negative electrode layer are entirely made of the lithium manganate powder and the graphite powder respectively, their electrical resistances are high. Accordingly, it takes a long time to charge or discharge the battery.

### SUMMARY

The disclosure provides a battery and an electronic device, which enable the battery to be charged and discharged rapidly.

Specific solutions are as follows.

A battery comprises:

a porous metal positive electrode plate having a plurality of pores filled with positive electrode material;

a porous metal negative electrode plate having a plurality of pores filled with negative electrode material;

a first separating film arranged between the porous metal positive electrode plate and the porous metal negative electrode plate; and

a second separating film covering a lower surface of the porous metal negative electrode plate, the lower surface is not in contact with the first separating film.

Optionally, the porous metal positive electrode plate has a thickness of 80 um to 250 um.

Optionally, the porous metal positive electrode plate is a current collecting plate made of aluminum.

Optionally, the positive electrode material is lithium cobaltate or lithium manganate powder.

Optionally, the porous metal negative electrode plate has a thickness of 80 um to 250 um.

Optionally, the porous metal negative electrode plate is a current collecting plate made of copper.

Optionally, the negative electrode material is graphite or petrol coke powder.

Optionally, the battery further comprises:

an aluminum foil plate covering an upper surface of the porous metal positive electrode plate, the upper surface is not in contact with the first separating film; and

a copper foil plate arranged between the second separating film and the porous metal negative electrode plate.

Optionally, the aluminum foil plate has a thickness of 5 um to 12 um.

Optionally, the copper foil plate has a thickness of 5 um to 12 um.

Optionally, the first separating film has a thickness of 5 um to 50 um and the second separating film has a thickness of 5 um to 50 um.

Optionally, the separating film is made of polyethylene, polypropylene or polyolefin.

An electronic device comprises the above-described battery.

The battery according to embodiments of the disclosure comprises: a porous metal positive electrode plate having a plurality of pores filled with positive electrode material, which is used in a cathode reaction within the battery; a porous metal negative electrode plate having a plurality of pores filled with negative electrode material, which is used in an anode reaction within the battery; a first separating film arranged between the porous metal positive electrode plate and the porous metal negative electrode plate; and a second separating film covering a lower surface of the porous metal negative electrode plate, the lower surface is not in contact with the first separating film. According to the disclosure, the battery's cathode and anode are made of porous metals respectively filled with the positive electrode material and the negative electrode material. As such, internal resistances of the positive and the negative electrodes of the battery are reduced, thereby enabling the battery to charged and discharged rapidly.

### BRIEF DESCRIPTION OF THE DRAWINGS

FIG. 1 is a diagram illustrating a structure of a battery according to the prior art;

FIG. 2 is a diagram illustrating a structure of a battery according to an embodiment of the disclosure; and

FIG. 3 is a diagram illustrating a structure of a battery according to another embodiment of the disclosure.

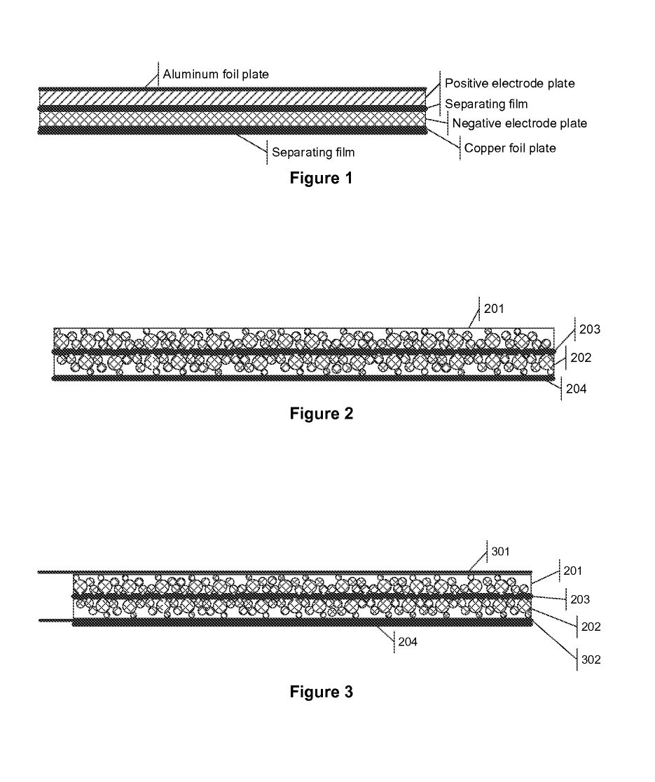

### DETAILED DESCRIPTION OF EMBODIMENTS

The disclosure provides a battery, comprising: a porous metal positive electrode plate having a plurality of pores filled with positive electrode material, which is used in a cathode reaction within the battery; a porous metal negative electrode plate having a plurality of pores filled with negative electrode material, which is used in an anode reaction within the battery; a first separating film arranged between the porous metal positive electrode plate and the porous metal negative electrode plate; and a second separating film covering a lower surface of the porous metal negative electrode plate, the lower surface is not in contact with the first separating film. According to the disclosure, the battery's cathode and anode are made of porous metals respectively filled with the positive electrode material and the negative electrode material. As such, internal resistances of the positive and the negative electrodes of the battery are reduced, thereby enabling the battery to charged and discharged rapidly.

In the following, detailed description will be given in conjunction with the accompanying drawings and specific embodiments.

FIG. 2 illustrates a structure of a battery according to an embodiment of the disclosure. The battery comprises:

a porous metal positive electrode plate 201 having a plurality of pores filled with positive electrode material;

a porous metal negative electrode plate 202 having a plurality of pores filled with negative electrode material;

a first separating film 203 arranged between the porous metal positive electrode plate 201 and the porous metal negative electrode plate 202; and

a second separating film 204 covering a lower surface of the porous metal negative electrode plate 202, the lower surface is not in contact with the first separating film 203.

Firstly, in an embodiment of the disclosure, a layer of the positive material, which may be lithium cobaltate or lithium manganate powder, is first applied onto a surface of a porous metal plate. Then, the porous metal plate, onto which the positive material is applied, is pressed, so that the positive electrode material may be forced into the porous metal plate and the pores of the porous metal plate may be filled with the positive electrode material. Generally speaking, the porous metal plate has a thickness of 0.5 mm to 1.5 mm before being pressed, while it has a thickness of 80 um to 250 um after being pressed. Finally, a porous metal positive electrode plate 201 as shown in FIG. 2 is obtained, with all its pores filled with the positive electrode material. As the pressing process is controllable, the thickness of the porous metal positive electrode plate 201 may be adapted to specific applications.

Further, in an embodiment of the disclosure, the porous metal positive electrode plate 201 is made of aluminum. Of course, adaptation may be made according to specific applications.

Likewise, in an embodiment of the disclosure, the porous metal negative electrode plate 202 is made according to the same process as the porous metal positive electrode plate 201, except that the porous metal negative electrode plate 202 is filled with negative material and made of copper. The negative material may be any of graphite powder, petrol coke powder, etc. However, the disclosure is not limited in this regard.

Of course, in an embodiment of the disclosure, the porous metal negative electrode plate 202 has a thickness of 0.5 mm to 1.5 mm before being pressed, and it may also have a thickness of 80 um to 250 um after being pressed.

Further, a first separating film 203 is additionally arranged between the porous metal positive electrode plate 201 and the porous metal negative electrode plate 202. As the first separating film 203, a separating film in an existing Lithium-ion battery may be used. Here, the thickness of the first separating film 203 may be set between 5 um and 50 um and is adaptable to specific applications.

Further, in addition to the first separating film 203 arranged between the porous metal positive electrode plate 201 and the porous metal negative electrode plate 202, a second separating film 204 is arranged on the lower surface of the porous metal negative electrode plate 202. The second separating film 204 covers the lower surface of the porous metal negative electrode plate 202, and its thickness is set between 5 um and 50 um. Here, the lower surface is a surface of the porous metal negative electrode plate 202 which is not in contact with the first separating film 203. Thus, a battery structure as shown in FIG. 2 is finally obtained. It shall be noted here that the material of the first separating film 203 and the second separating film 204 may be any of polyethylene, polypropylene or polyolefin.

In the embodiments of the disclosure, the porous metal positive electrode plate 201 filled with the positive electrode material is used as the cathode of the battery and the porous metal negative electrode plate 202 is used as the anode of the battery. Because of the positive electrode material in the porous metal positive electrode plate 201 and the negative electrode material in the porous metal negative electrode plate 202, internal resistances of the battery's cathode and anode are reduced to a large extent. Accordingly, electrons in the battery's cathode may be moved to the anode quickly, thereby enabling the battery to be discharged rapidly. Likewise, a rapid charge of the battery may be achieved.

Further, in an embodiment of the disclosure, to avoid shorting the porous metal positive electrode plate 201 and the porous metal negative electrode plate 202, the battery further comprises an aluminum foil plate 301 and a copper foil plate 302 as shown in FIG. 3. The aluminum foil plate 301 covers the upper surface of the porous metal positive electrode plate 201, the upper surface is not in contact with the first separating film 203. The copper foil plate 302 is arranged between the second separating film 204 and the porous metal negative electrode plate 202. Due to the existence of the aluminum foil plate 301 and the copper foil plate 302, electrons in the porous metal positive electrode plate 201 may still be transferred to the porous metal negative electrode plate 202 via the aluminum foil plate 301, even if the porous metal positive electrode plate 201 breaks. Likewise, even if the porous metal negative electrode plate 202 breaks, it still can be ensured that electrons in the porous metal positive electrode plate 201 may be transferred to the porous metal negative electrode plate 202. Thus, shorting due to the breakage of the porous metal positive electrode plate 201 and/or the porous metal negative electrode plate 202 can be avoided, thereby ensuring the stability and the security of the entire battery.

Further, in an embodiment of the disclosure, to reduce the thickness of the entire battery, the thickness of the aluminum foil plate 301 may be 5 um to 12 um, and the thickness of the copper foil plate 302 may be 5 um to 12 um. In practical application, the thicknesses of the aluminum foil plate 301 and the copper foil plate 302 may be adaptable to certain scenarios, which are described here.

Further, in an embodiment of the disclosure, to ensure that the battery can be charged and discharged rapidly, in the above embodiments, positive electrode material is filled into the pores of the porous metal positive electrode plate 201, rather than coating the porous metal positive electrode plate 201 with a layer of positive electrode material. Also, negative electrode material is filled into the pores of the porous metal negative electrode plate 202, rather than coating the porous metal negative electrode plate 202 with a layer of negative electrode material.

Since the capacity of the battery is proportional to the number of lithium ions, in an embodiment of the disclosure, a layer of positive electrode material may be further coated on a surface of the porous metal positive electrode plate 201 which is in contact with the first separating film 203, so as to increase the content of lithium ions, and a layer of negative electrode material may be coated on a surface of the porous metal negative electrode plate 202, so that chemical reactions within the battery can proceed rapidly. Accordingly, the capacity of the battery may be increased by further coating the surface of the porous metal plate with the positive electrode material.

Here, it shall be noted that, in practical application, whether or not to apply the coatings of the positive electrode material and/or the negative electrode material and how thick the coatings of the positive electrode material and/or the negative electrode material are may be adaptively determined according to requirements for the capacity and the discharge rate of the battery. As such, a tradeoff between the discharge rate and the capacity of the battery may be achieved.

In addition, the disclosure further provides an electronic device, comprising:

a housing;

a processing unit; and

a battery according to any of the above embodiments, the battery being connected to the processing unit.

Although preferable embodiments of the disclosure have been described, those skilled in the art may make various alterations and changes to the embodiments upon understanding the fundamental inventive concept. Therefore, the claims appended below are intended to be interpreted as encompassing the preferable embodiments as well as all alterations and changes that fall within the scope of the disclosure.

Obviously, those skilled in the art may make various alterations and changes to the disclosure without departing from the spirit and scope thereof. Thus, if these alterations and changes fall within the scope of the claims and the technical equivalents thereof, they are intended to be covered by the disclosure.

What is claimed is:

1. A battery, comprising:
a porous metal positive electrode plate having a plurality of pores filled with positive electrode material;
a porous metal negative electrode plate having a plurality of pores filled with negative electrode material;
a first separating film arranged between the porous metal positive electrode plate and the porous metal negative electrode plate; and
a second separating film covering a lower surface of the porous metal negative electrode plate, the lower surface is not in contact with the first separating film.

2. The battery according to claim 1, wherein the porous metal positive electrode plate has a thickness of 80 um to 250 um.

3. The battery according to claim 1, wherein the porous metal positive electrode plate is a current collecting plate made of aluminum.

4. The battery according to claim 1, wherein the positive electrode material is lithium cobaltate or lithium manganate powder.

5. The battery according to claim 1, wherein the porous metal negative electrode plate has a thickness of 80 um to 250 um.

6. The battery according to claim 1, wherein the porous metal negative electrode plate is a current collecting plate made of copper.

7. The battery according to claim 1, wherein the negative electrode material is graphite or petrol coke powder.

8. The battery according to claim 1, further comprising:
an aluminum foil plate covering an upper surface of the porous metal positive electrode plate, the upper surface is not in contact with the first separating film; and
a copper foil plate arranged between the second separating film and the porous metal negative electrode plate.

9. The battery according to claim 8, wherein the aluminum foil plate has a thickness of 5 um to 12 um.

10. The battery according to claim 8, wherein the copper foil plate has a thickness of 5 um to 12 um.

11. The battery according to claim 1, wherein the first separating film has a thickness of 5 um to 50 um, and the second separating film has a thickness of 5 um to 50 um.

12. The battery according to claim 1, wherein the separating film is made of polyethylene, polypropylene or polyolefin.

13. An electronic device comprising a battery according to any of claim 1.
